(19) United States
(12) Patent Application Publication
(10) Pub. No.: US 2024/0103203 A1
(43) Pub. Date: Mar. 28, 2024

(54) LENS ARRAY

(71) Applicant: Young Optics Inc., Hsinchu Science Park (TW)

(72) Inventors: TSUNG-TA LEE, Hsinchu Science Park (TW); YU-PO CHEN, Hsinchu Science Park (TW)

(21) Appl. No.: 18/462,943

(22) Filed: Sep. 7, 2023

(30) Foreign Application Priority Data
Sep. 23, 2022 (TW) 111136264

(51) Int. Cl. G02B 3/00; G02B 1/04; G02B 7/02; G02B 17/00

(52) U.S. Cl. CPC G02B 3/0062; G02B 1/041; G02B 7/021; G02B 17/002

(57) ABSTRACT

A lens array includes an edge lens region provided with multiple first type lenslets, a middle lens region provided with multiple second type lenslets and a center lens region provided with multiple third type lenslets. One of the first type lenslets has a first curved surface with a first vertex, one of the second type lenslets has a second curved surface with a second vertex, and one of the third type lenslets has a third curved surface with a third vertex. A first tangent plane to the first curved surface at the first vertex, a second tangent plane to the second curved surface at the second vertex, and a third tangent plane to the third curved surface at the third vertex are parallel to or coincide with each other.

### CROSS-REFERENCE TO RELATED APPLICATION

This application claims the priority benefit of Taiwan application serial no. 111136264, filed Sep. 23, 2022. The entirety of the above-mentioned patent application is hereby incorporated by reference herein and made a part of this specification.

### BACKGROUND

### Field of the Invention

The invention relates to a lens array.

### Description of the Related Art

In current projector illumination systems, a microlens array (MLA) is commonly used as a light-homogenizing element. Multiple lenslets arranged on a first side surface of the microlens array divide non-uniform incident light beams into an array of tiny light spots, and then the array of tiny light spots are focused on corresponding lenslets on a second side surface of the microlens array. Subsequently, each of the tiny light spots is scaled according to the shape of the individual lenslet and then superposed to provide an equal spot size at each illumination position, thus achieving the effect of homogenizing light beams and shaping an output light pattern. However, some lenslets located far away from the optical axis of the microlens array are liable to produce distorted light spots due to aberration to result in blurred edges of light spots and thus reduce the imaging quality of a projector.

### BRIEF SUMMARY OF THE INVENTION

In order to achieve one or a portion of or all of the objects or other objects, one embodiment of the invention provides a lens array includes an edge lens region, a middle lens region and a center lens region. The edge lens region is at a periphery of the lens array and provided with multiple first type lenslets, and one of the first type lenslets has a first curved surface with a first vertex. The middle lens region is adjacent to the edge lens region and provided with multiple second type lenslets, one of the second type lenslets has a second curved surface with a second vertex, and the second curved surface is adjacent to the first curved surface. The center lens region is adjacent to the middle lens region and provided with multiple third type lenslets, one of the third type lenslets has a third curved surface with a third vertex, and the third curved surface is adjacent to the second curved surface. The lens array satisfies the following conditions: (1) the center lens region are provided with at least three consecutive rows of the third type lenslets; (2) a distance L1 is not equal to a distance L2, where the distance L1 is a distance between the first vertex and the second vertex, and the distance L2 is a distance between the second vertex and the third vertex, and each of the distance L1 and the distance L2 has a fixed value; and (3) a first tangent plane to the first curved surface at the first vertex, a second tangent plane to the second curved surface at the second vertex, and a third tangent plane to the third curved surface at the third vertex are parallel to or coincide with each other.

Another embodiment of the invention provides a lens array includes a first row of lenslets, a second row of lenslets and a third row of lenslets. The first row of lenslets is disposed on an outermost side of the lens array and includes multiple first type lenslets, and one of the first type lenslets has a first curved surface with a first vertex. The second row of lenslets adjoins the first row of lenslets and includes multiple second type lenslets, one of the second type lenslets has a second curved surface with a second vertex, and the second curved surface adjoins the first curved surface. The third row of lenslets adjoins the second row of lenslets and includes multiple third type lenslets, one of the third type lenslets has a third curved surface with a third vertex, and the third curved surface adjoins the second curved surface. The lens array satisfies the following conditions: (1) a distance L1 is not equal to a distance L2, where the distance L1 is a distance between the first vertex and the second vertex, and the distance L2 is a distance between the second vertex and the third vertex; and (2) the second curved surface is symmetrical about two orthogonal planes passing through the second vertex, and the third curved surface is symmetrical about two orthogonal planes passing through the third vertex.

According to the above embodiments, the lens array of the invention may have at least one of the following advantages. Through the design of the embodiments, the size, shape, or material of lenslets at the periphery of the lens array may differ from the size, shape, or material of lenslets in other region of the lens array to change the magnification or focal length of the edge lenslets and thus achieve the effect of locally adjusting the distribution of light energy. This allows to shrink the produced light spots to match an ideal scope of target light spots and sharpen the edge of the produced light spots to thus improve the quality of projection images. Besides, various parameters of a lenslet can be adjusted to vary the magnification or focal length of the lenslet, and parameter values of lenslets can be set to have gradual variations to obtain a magnification gradient across the lens array and thus achieve a smooth change in light energy for the adjustment of light energy distribution.

Other objectives, features and advantages of the invention will be further understood from the further technological features disclosed by the embodiments of the invention wherein there are shown and described preferred embodiments of this invention, simply by way of illustration of modes best suited to carry out the invention.

### BRIEF DESCRIPTION OF THE DRAWINGS

FIG. 1 is a schematic diagram of a lens array according to an embodiment of the invention.

FIG. 2 is a schematic diagram showing a lens structure design according to an embodiment of the invention.

FIGS. 3A, 3B and 3C are schematic diagrams showing a lens structure design according to another embodiment of the invention.

FIG. 4 is a schematic diagram of a lens array according to another embodiment of the invention.

FIG. 5 is a schematic diagram illustrating achieving effects of the lens array according to an embodiment of the invention.

FIG. 6 is a schematic diagram of a lens array according to another embodiment of the invention.

FIG. 7 is a schematic diagram of a lens array according to another embodiment of the invention.

FIGS. 8A, 8B, 8C and 8D are schematic diagrams showing different gradient designs of a lens array according to various embodiments of the invention.

### DETAILED DESCRIPTION OF THE INVENTION

In the following detailed description of the preferred embodiments, directional terminology, such as “top,” “bottom,” “front,” “back,” etc., is used with reference to the orientation of the Figure(s) being described. The components of the invention can be positioned in a number of different orientations. As such, the directional terminology is used for purposes of illustration and is in no way limiting. Further, “First,” “Second,” etc, as used herein, are used as labels for nouns that they precede, and do not imply any type of ordering (e.g., spatial, temporal, logical, etc.).

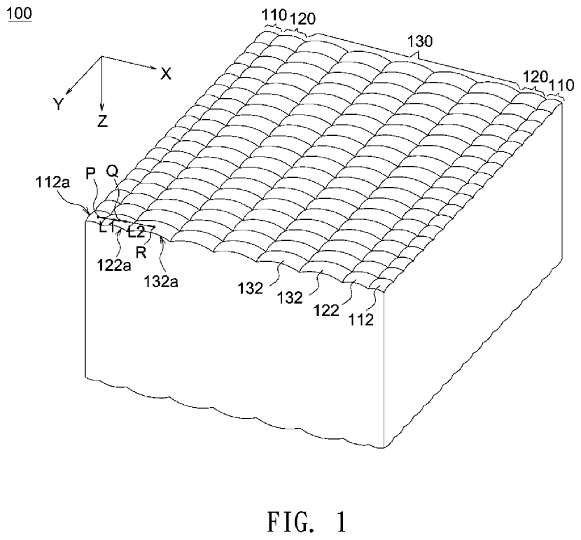

FIG. 1 is a schematic diagram of a lens array according to an embodiment of the invention. Referring to FIG. 1, in this embodiment, a lens array 100 includes an edge lens region 110, a middle lens region 120, and a center lens region 130 arranged along an X-axis direction. The edge lens region 110 is located at the periphery of the lens array 100 and provided with multiple first type lenslets 112 arranged in a row along a Y-axis direction. The middle lens region 120 is adjacent to the edge lens region 110 and provided with multiple second type lenslets 122 arranged in at least one row along the Y-axis direction. The center lens region 130 is adjacent to the middle lens region 120 and provided with multiple third type lenslets 132 arranged in at least three continuous rows along the Y-axis direction (for example, five continuous rows of the third type lenslets 132 as shown in FIG. 1). The lens array 100 may be, for example, used in an optical projection system for homogenizing incoming light beams and/or shaping output light patterns. In this embodiment, the center lens region 130, the middle lens region 120 and the edge lens region 110 are arranged in order from the center to the periphery of the lens array 100. The first type lenslet 112 has a curved surface 112a, and the curved surface 112a has a vertex P. The second type lenslet 122 has a curved surface 122a adjacent to the curved surface 112a, and the curved surface 122a has a vertex Q. The third type lenslet 132 has a curved surface 132a adjacent to the curved surface 122a, and the curved surface 132a has a vertex R. A distance between the vertex P and the vertex Q is denoted as L1, a distance between the vertex Q and the vertex R is denoted as L2, both distances L1 and L2 are fixed values, and the distance L2 is not equal to the distance L1. In this embodiment, the distance L1 between the vertex P and the vertex Q is less than the distance L2 between the vertex Q and the vertex R. Furthermore, in this embodiment, a length of one third type lenslet 132 in the center lens region 130 is greater than a length of one second type lenslet 122 in the middle lens region 120, and a length of one second type lenslet 122 in the middle lens region 120 is greater than a length of one first type lenslet 112 in the edge lens region 110, where these lengths are measured in a direction parallel to a line connecting the vertex Q and the vertex R. Moreover, in this embodiment, each of the first type lenslets 112, the second type lenslets 122, and the third type lenslets 132 have the same length in the Y-axis direction, and the first type lenslets 112 and the second type lenslets 122 have different curved surface shapes, but the invention is not limited thereto. In addition, the lens array 100 may be a transmissive-type lens array or a reflective-type lens array without limitation.

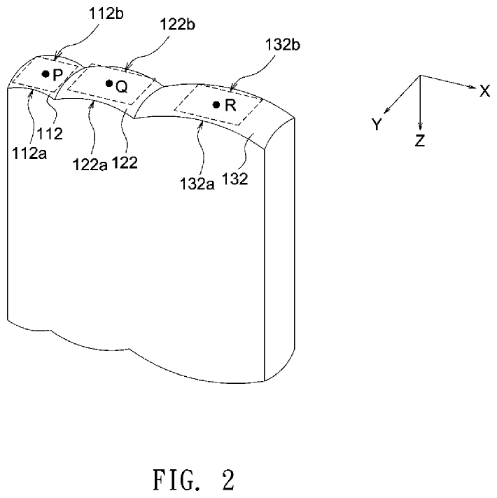

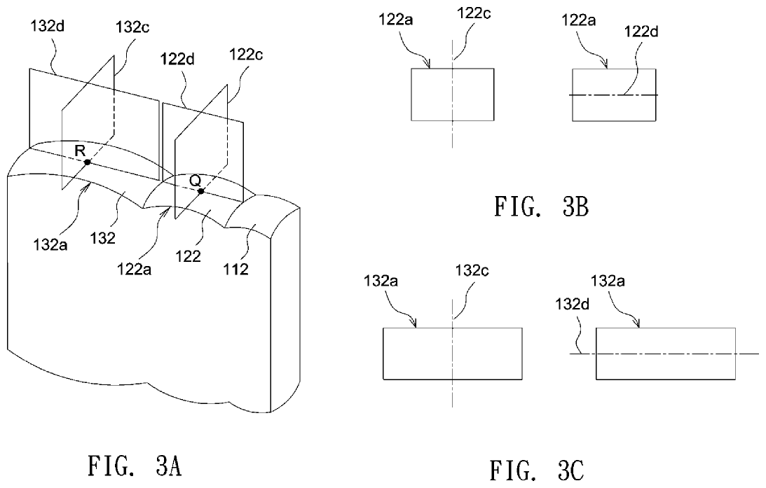

FIG. 2 is a schematic diagram showing a lens structure design according to an embodiment of the invention. As shown in FIG. 2, in one embodiment, the first type lenslet 112, the second type lenslet 122 and the third type lenslet 132 respectively have a curved surface 112a, a curved surface 122a and the curved surface 132a, and a tangent plane 112b to the curved surface 112a at the vertex P, a tangent plane 122b to the curved surface 122a at the vertex Q and a tangent plane 132b to the curved surface 132a at the vertex R are parallel to or coincide with each other. FIGS. 3A, 3B and 3C are schematic diagrams showing a lens structure design according to another embodiment of the invention. In this embodiment, the lens structure design is defined by the shape of a curve surface relative to orthogonal virtual planes. As shown in FIG. 3A, two orthogonal planes 122c and 122d pass through the vertex Q of the curved surface 122a, and two orthogonal planes 132c and 132d pass through the vertex R of the curved surface 132a. Then, the curved surface 122a of the second type lenslet 122 can be designed to be both symmetrical about the plane 122c and symmetrical about the plane 122d as shown in FIG. 3B, and the curved surface 132a of the third type lenslet 132 can be designed to be both symmetrical about the plane 132c and symmetrical about the plane 132 as shown in FIG. 3C. That is, the curved surface 122a can be symmetrical about the two orthogonal planes 122c and 122d that pass through the vertex Q of the curved surface 122a, and the curved surface 132a can be symmetrical about the two orthogonal planes 132c and 132d that pass through the vertex R of the curved surface 132a.

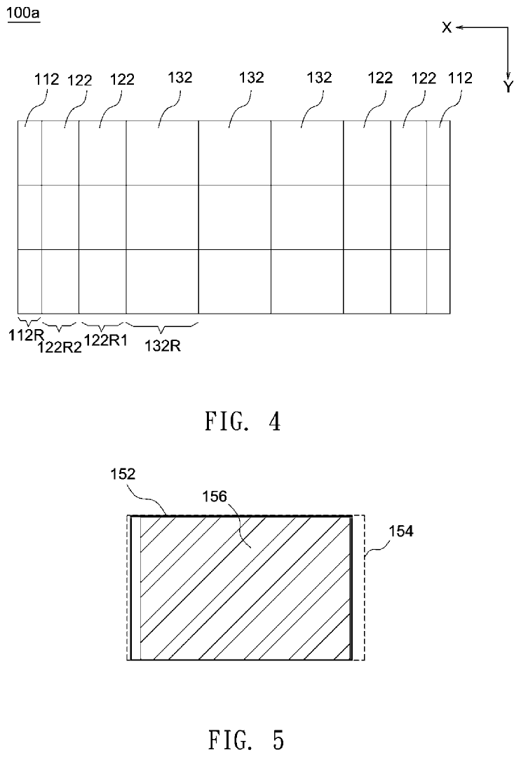

FIG. 4 is a schematic diagram of a lens array according to another embodiment of the invention. As shown in FIG. 4, the second type lenslets 122 in the middle lens region 120 are arranged along the Y-axis direction to form multiple lens rows 122R1 and 122R2, the third type lenslets 132 are arranged along the Y-axis direction to from multiple lens rows 132R, and the first type lenslets 112 are arranged along the Y-axis direction to from multiple lens rows 112R. In this embodiment, the lens row 122R1 adjoins the lens row 132R, and the lens row 122R2 adjoins the lens row 112R. In this embodiment, the lens row 112R is located on the outermost side of the lens array 100a, and, in the lens array 100a, the lengths of lenslets measured along the X-axis direction has a gradient change; that is, in terms of the lengths in the X-axis direction, the lens row 122R1 is less than the lens row 132R, the lens row 122R2 is less than the lens row 122R1, and the lens row 112R is less than the lens row 122R2.

Through the design of the above embodiments, because the size of lenslets at the periphery of a lens array is designed to be different from the size of lenslets in other areas, the effect of locally adjusting the light energy distribution can be achieved. For example, as shown in FIG. 5, an ideal scope for target light spots 152 of the lens array is represented by a bold solid box. A conventional lens array where all lenslets are of the same size may produce deformed light spots 154 (indicated by a dashed box) that often extend to the outside of the ideal scope due to aberration, thus resulting in blurred edges of light spot images with poor contrast. According to the above embodiments, for example, the size of lenslets at the periphery of a lens array can be set to be smaller as compared with other areas to change the magnification or focal length of lenslets at the periphery and thus achieve the effect of locally adjusting the light energy distribution. This allows to shrink the scope of produced light spots 156 (indicated by hatched lines) to match the ideal scope of light spots and sharpen the edge of light spot images. Furthermore, the lens array according to the above embodiments may have size gradient to gradually change the light energy for the adjustment of light energy distribution.

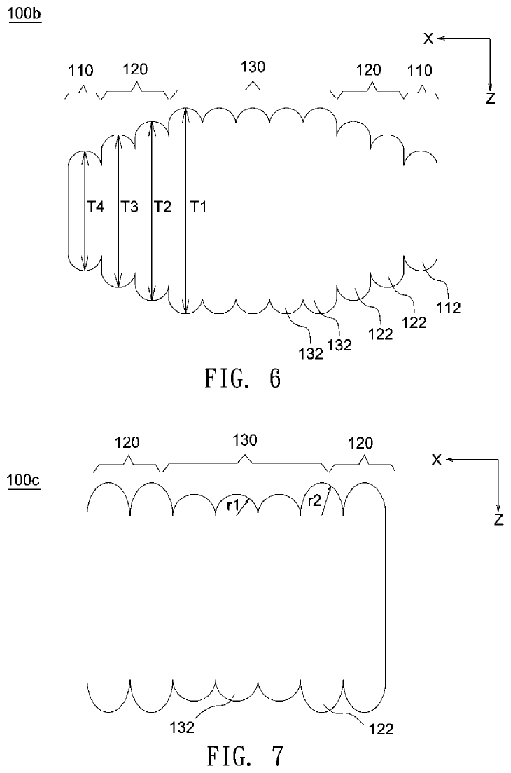

FIG. 6 is a schematic diagram of a lens array according to another embodiment of the invention. As shown in FIG. 6, thicknesses of the second type lenslets 122 in the middle lens region 120 of the lens array 100b may differ from thicknesses of the third type lenslets 132 in the center lens region 130. For example, thicknesses of the second type lenslets 122 may be smaller than thicknesses of the third type lenslets 132. Besides, thicknesses of the first type lenslets 112 in the edge lens region 110 may differ from thicknesses of second type lenslets 122 in the middle lens region 120. When the thickness is decreased, the magnification of a lenslet can be reduced to shrink the scope of produced light spots to match an ideal scope as shown in FIG. 5. In this embodiment, the thickness of lenslets may gradually change from the center lens region 130 to either side of the lens array 100b. For example, the thickness of lenslets may gradually decrease in a direction away from the center lens region 130 (i.e., thickness T1>thickness T2>thickness T3>thickness T4). Such thicknesses gradient design may achieve a smooth change in light energy for the adjustment of light energy distribution.

FIG. 7 is a schematic diagram of a lens array according to another embodiment of the invention. As shown in FIG. 7, the radius of curvature of each second type lenslet 122 in the middle lens region 120 of the lens array 100c may differ from the radius of curvature of each third type lenslet 132 in the center lens region 130, so that the second type lenslet 122 and the third type lenslet 132 have different surface shapes. For example, the radius of curvature r2 of the second type lenslet 122 can be greater than the radius of curvature r1 of the third type lenslet 132 (that is, the surface curvature of the second type lens 122 is less than the surface curvature of the third type lens 132). When the surface curvature of a lenslet is reduced, the magnification of the lenslet can be reduced to shrink the scope of produced light spots to match an ideal scope as shown in FIG. 5.

According to the above embodiments, by differentiating the area, material (refractive index), shape or thickness of lenslets located outside a central region from those of lenslets in the central region of a lens array, the magnification of the lens array can be locally adjusted to achieve the effect of regionally adjusting the light energy distribution, and as much as possible making the produced light spots match an ideal scope of target light spots.

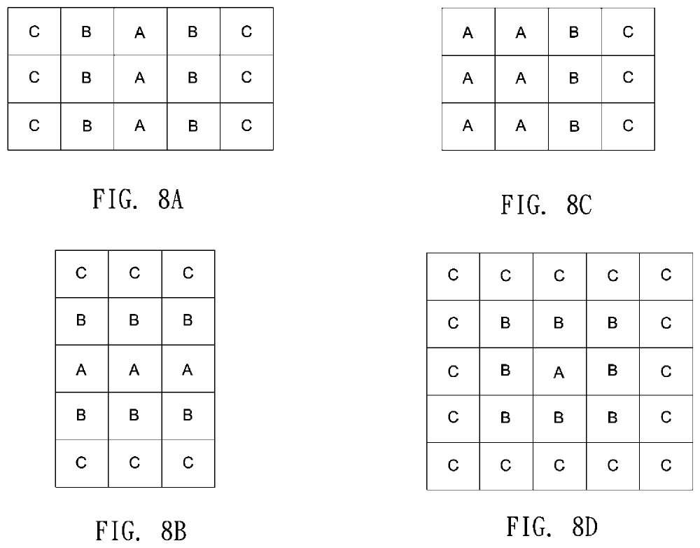

FIGS. 8A-8D are schematic diagrams showing the gradient design of a lens array according to various embodiments of the invention. In at least some embodiments of the invention, various parameters of a lenslet, such as the lens area, length, thickness, refractive index or radius of curvature, can be adjusted to vary the magnification or focal length of the lenslet, and the parameter values of lenslets can be set to have gradual variations to achieve a magnification gradient across the lens array. For example, assuming the thickness of a lens A is greater than the thickness of a lens B, and the thickness of the lens B is greater than the thickness of lens C, FIG. 8A shows a lenslet arrangement where the thickness is gradually decreased in a horizontal direction from the center to either side of the lens array, and FIG. 8B shows a lenslet arrangement where the thickness is gradually decreased in a vertical direction from the center to either side of the lens array. In another embodiment as shown in FIG. 8C, the thickness of the lens array is gradually changed towards only on one side. Furthermore, as shown in FIG. 8D, the thickness of the lens array is gradually changed in a radial direction from the center (i.e. having a concentric thickness gradient). Note the above example in terms of the thickness gradient is described merely for exemplified purposes but not restricting the invention. Other parameters such as the lens area, length, refractive index, or radius of curvature can be also used to gradually adjust the magnification of a lens array. Additionally, the dimensional gradient or distribution of lenslets may vary according to actual needs without limitation.

Based on the above, the lens array of the invention may have at least one of the following advantages. Through the design of the embodiments, the size, shape, or material of lenslets at the periphery of the lens array may differ from the size, shape, or material of lenslets in other region of the lens array to change the magnification or focal length of the edge lenslets and thus achieve the effect of locally adjusting the distribution of light energy. This allows to shrink the produced light spots to match an ideal scope of target light spots and sharpen the edge of the produced light spots to thus improve the quality of projection images. Besides, various parameters of a lenslet can be adjusted to vary the magnification or focal length of the lenslet, and parameter values of lenslets can be set to have gradual variations to obtain a magnification gradient across the lens array and thus achieve a smooth change in light energy for the adjustment of light energy distribution.

Though the embodiments of the invention have been presented for purposes of illustration and description, they are not intended to be exhaustive or to limit the invention. Accordingly, many modifications and variations without departing from the spirit of the invention or essential characteristics thereof will be apparent to practitioners skilled in this art. It is intended that the scope of the invention be defined by the claims appended hereto and their equivalents in which all terms are meant in their broadest reasonable sense unless otherwise indicated.

What is claimed is:

1. A lens array, comprising:
an edge lens region at a periphery of the lens array and provided with multiple first type lenslets, and one of the first type lenslets having a first curved surface with a first vertex;
a middle lens region adjacent to the edge lens region and provided with multiple second type lenslets, one of the second type lenslets having a second curved surface with a second vertex, and the second curved surface being adjacent to the first curved surface; and
a center lens region adjacent to the middle lens region and provided with multiple third type lenslets, one of the third type lenslets having a third curved surface with a third vertex, and the third curved surface being adjacent to the second curved surface;
wherein the lens array satisfies the following conditions:
(1) the center lens region are provided with at least three consecutive rows of the third type lenslets;
(2) a distance L1 is not equal to a distance L2, where the distance L1 is a distance between the first vertex and the second vertex, and the distance L2 is a distance between the second vertex and the third vertex; and
(3) a first tangent plane to the first curved surface at the first vertex, a second tangent plane to the second curved surface at the second vertex, and a third tangent plane to the third curved surface at the third vertex are parallel to or coincide with each other.

2. The lens array as claimed in claim 1, wherein a shape of the first curved surface differs from a shape of the second curved surface.

3. The lens array as claimed in claim 1, wherein materials, shapes, or sizes of the first type lenslets and the second type lenslets differ from materials, shapes, or sizes of the third type lenslets.

4. The lens array as claimed in claim 1, wherein a length of each of the second type lenslets measured in a first direction parallel to a line connecting the second vertex and the third vertex is less than a length of each of the third type lenslets measured in the first direction.

5. The lens array as claimed in claim 4, wherein a length of each of the second type lenslets measured in a second direction perpendicular to the first direction is equal to a length of each of the third type lenslets measured in the second direction.

6. The lens array as claimed in claim 1, wherein a thickness of each of the second type lenslets is smaller than a thickness of each of the third type lenslets.

7. The lens array as claimed in claim 1, wherein a radius of curvature of each of the second type lenslets is greater than a radius of curvature of each of the third type lenslets.

8. The lens array as claimed in claim 1, wherein each of the lenslets has at least one parameter capable of being changed to adjust a magnification of the lenslet, the at least one parameter includes at least one of an area, a length, a thickness, a refractive index, and a radius of curvature of the lenslet, and values for the at least one parameter of the lenslets are set to have gradual variations across the lens array.

9. The lens array as claimed in claim 8, wherein the values for the at least one parameter of the lenslets are gradually decrease or increase from a center towards either side of the lens array.

10. The lens array as claimed in claim 1, wherein the lens array is a transmissive-type lens array or a reflective-type lens array.

11. A lens array, comprising:
multiple first type lenslets provided on an edge lens region at a periphery of the lens array and arranged to form at least one first row, and one of the first type lenslets having a first curved surface with a first vertex;
multiple second type lenslets provided on a middle lens region adjacent to the edge lens region and arranged to form at least one second row, one of the second type lenslets having a second curved surface with a second vertex, and the second curved surface being adjacent to the first curved surface; and
multiple third type lenslets provided on a center lens region adjacent to the middle lens region and arranged to form at least one third row, one of the third type lenslets having a third curved surface with a third vertex, and the third curved surface being adjacent to the second curved surface;
wherein the lens array satisfies the following conditions:
(1) the center lens region are provided with at least three third rows of the third type lenslets;
(2) a distance L1 is not equal to a distance L2, where the distance L1 is a distance between the first vertex and the second vertex, the distance L2 is a distance between the second vertex and the third vertex, and each of the distance L1 and the distance L2 has a fixed value;
(3) a first tangent plane to the first curved surface at the first vertex, a second tangent plane to the second curved surface at the second vertex, and a third tangent plane to the third curved surface at the third vertex are parallel to or coincide with each other; and
(4) the second curved surface is symmetrical about two orthogonal planes passing through the second vertex, and the third curved surface is symmetrical about two orthogonal planes passing through the third vertex.

12. The lens array as claimed in claim 11, wherein a shape of the first curved surface differs from a shape of the second curved surface.

13. The lens array as claimed in claim 11, wherein materials, shapes, or sizes of the first type lenslets and the second type lenslets differ from materials, shapes, or sizes of the third type lenslets.

14. The lens array as claimed in claim 11, wherein a length of each of the second type lenslets measured in a first direction parallel to a line connecting the second vertex and the third vertex is less than a length of each of the third type lenslets measured in the first direction, and a length of each of the first type lenslets measured in the first direction is less than the length of each of the second type lenslets measured in the first direction.

15. The lens array as claimed in claim 14, wherein a length of each of the second type lenslets measured in a second direction perpendicular to the first direction is equal to a length of each of the third type lenslets measured in the second direction.

16. The lens array as claimed in claim 11, wherein a thickness of each of the second type lenslets is smaller than a thickness of each of the third type lenslets, and a thickness of each of the first type lenslets is smaller than the thickness of each of the second type lenslets.

17. The lens array as claimed in claim 11, wherein a radius of curvature of each of the second type lenslets is greater than a radius of curvature of each of the third type lenslets.

18. The lens array as claimed in claim 11, wherein each of the lenslets has at least one parameter capable of being changed to adjust a magnification of the lenslet, the at least one parameter includes at least one of an area, a length, a thickness, a refractive index, and a radius of curvature of the lenslet, and values for the at least one parameter of the lenslets are set to have gradual variations across the lens array.

19. The lens array as claimed in claim 18, wherein the values for the at least one parameter of the lenslets are gradually decrease or increase from a center towards either side of the lens array.

20. The lens array as claimed in claim 11, wherein the lens array is a transmissive-type lens array or a reflective-type lens array.
